(19) United States
(12) Patent Application Publication
(10) Pub. No.: US 2002/0117549 A1
(43) Pub. Date: Aug. 29, 2002

(54) Barcode-readable computer mouse

(76) Inventor: Martin Lee, Taipei (TW)

Correspondence Address: Martin Lee, 235 Chung - Ho Box 8-24, Taipei, TW

(21) Appl. No.: 09/973,549

(22) Filed: Oct. 9, 2001

(30) Foreign Application Priority Data
Feb. 26, 2001 (TW) 090202858

(51) Int. Cl. G06K 7/10; G06K 9/22

(52) U.S. Cl. 235/462.45

(57) ABSTRACT

A barcode-readable computer mouse is disclosed. A barcode scanner is integrated into a computer mouse. The barcode-readable computer mouse comprises at least one mouse key, at least one mouse sensor, a barcode sensor, a circuit board, and a trigger means. The barcode sensor is selected from a contact type barcode sensor and a non-contact type barcode sensor and is installed at one of the end portions or the bottom of a computer mouse. Moreover, the barcode image sensor is selected from a group containing a CCD sensor, an optic pen sensor, and a laser sensor. The mouse sensor is selected from a group containing a wired computer mouse and a wireless computer mouse. Therefore, it has both functions of a controller and a barcode reading device. Moreover, the data outputted from a mouse is transferred to a connected web-cite using a browser.

### BACKGROUND OF THE INVENTION

1. Field of the Invention

The present invention relates to a computer mouse, and particularly to a barcode-readable computer mouse.

2. Description of Related Art

Referring to FIG. 9, a current computer device includes a computer mainframe 90, a keyboard 91, a mouse 921 and a screen 95. In practical applications, for example, scanning barcodes for a product and accounting of products in a supermarket, barcode scanners are necessary. As shown in the figure, the barcode scanner is classified as contact type photo pen scanners 93, non-contact palm top scanners 94 or fixed type barcode scanners (not shown). In case of an optic pen scanner 93, in operation, as shown in FIG. 10, the photo pen directly contacts the barcode, and then the photo pen slides through the barcode for reading the data on the barcode. The palm top scanner 94 is installed with a light emitter and has a structure slightly different from the photo pen scanner. In use, it is only necessary to align the lens to the barcodes, and then the barcodes can be read by the scanner to contact and slide through the barcodes.

Above prior art scanner has only the function of reading data of barcodes and thus the computer device must be installed with an extra barcode scanner. However, the mouse has become a necessary peripheral for a computer and in general, most of the operation of the computer must be performed by a mouse. Thus if a mouse can be integrated with the function of a barcode scanner, then the user may operate the two functions through only one device. Therefore, the operations are conveniently and time for operation can be saved.

### SUMMARY OF THE INVENTION

Accordingly, the primary object of the present invention is to provide a barcode-readable computer mouse which has the functions of a controller and a barcode reading device.

Another object of the present invention is to provide a barcode-readable computer mouse, wherein the computer mouse has a scanning module and a switching module. The operation is switched in these two modules. It can be connected to the original mouse cable for transferring these two signals without installing any extra wires.

A further object of the present invention is to provide a barcode-readable computer mouse, wherein the barcode sensor is selected from a group containing a contact type barcode sensor and a non-contact type barcode sensor. The data outputted from a mouse is transferred to a connected web-cite using a browser.

The various objects and advantages of the present invention will be more readily understood from the following detailed description when read in conjunction with the appended drawing.

### BRIEF DESCRIPTION OF THE DRAWINGS

FIGS. 1A to 1D shows the schematic views of the structure of the present invention.

FIG. 2 shows one embodiment of the present invention.

FIG. 3 shows one application of the present invention.

FIGS. 4A to 4B are schematic view about one application of the present invention.

FIGS. 5A to 5B are schematic view about another application of the present invention.

FIG. 6 shows another embodiment of the present invention.

FIG. 7 shows a circuit block diagram of the present invention.

FIG. 8 shows a flow diagram of the present invention.

FIG. 9 is a perspective view of a prior computer.

FIG. 10 is a schematic view of a prior barcode reading device.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

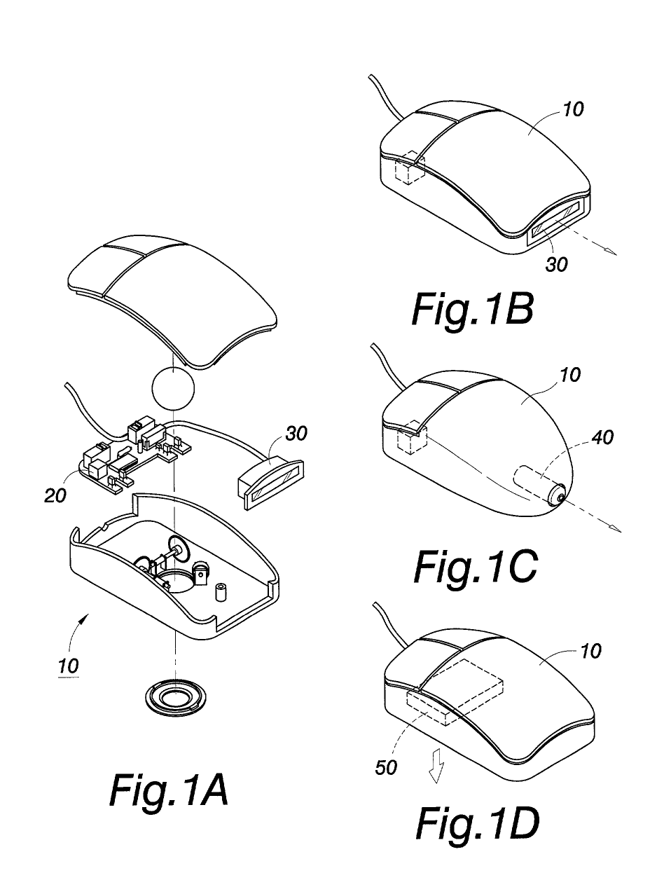

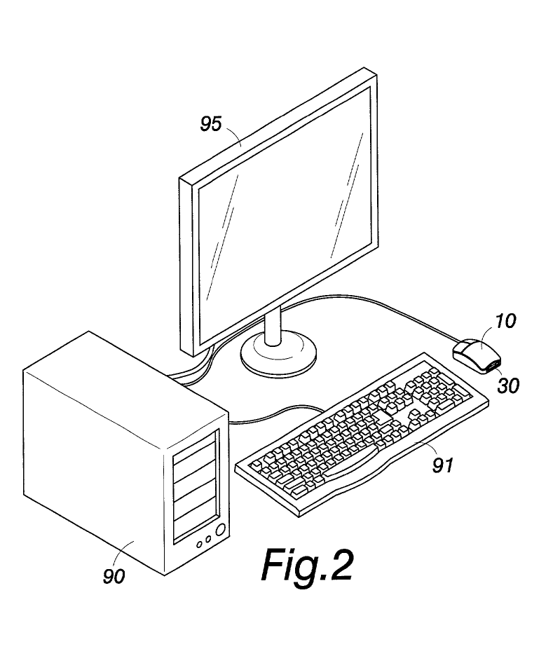

Referring to FIG. 1A, a barcode-readable computer mouse of the present invention is illustrated. In the present invention, the computer mouse 10 includes a circuit board 20 having a scanning decoding module and mouse module and a barcode sensor 30 installed at a selected position (front side, rear side or bottom) of the mouse. In the embodiment of FIG. 1A, the barcode sensor 30 is installed at one end portion of the computer mouse 10 (FIG. 1B shows the state after assembled), or as illustrated in FIG. 1D, the barcode sensor 50 is installed at a bottom of the computer mouse 10. The installing position may be varied properly based on the shape of the barcode sensor. FIG. 1B shows an example that a photo pen sensor 40 is used as a barcode sensor. Moreover, a laser sensor or other contact type sensors or non-contact sensors may be used as the barcode sensor in the present invention.

In the present invention, not only the barcode-scanning device is integrated into a mouse, but also in the design of a circuit board, the two are integrated as an integral body. Thereby, by a switch, the barcode-readable computer mouse of the present invention can be operated in a barcode scanning mode or a mouse mode. Only the original equipped RS232, PS/2 or USB signal wire is used to transfer barcode data and mouse signals. No any scanner transmission line is required. This is helpful to reduce the number of transmission line of a computer. Moreover, the installing work is simplified. Therefore, it is a highly compact computer mouse.

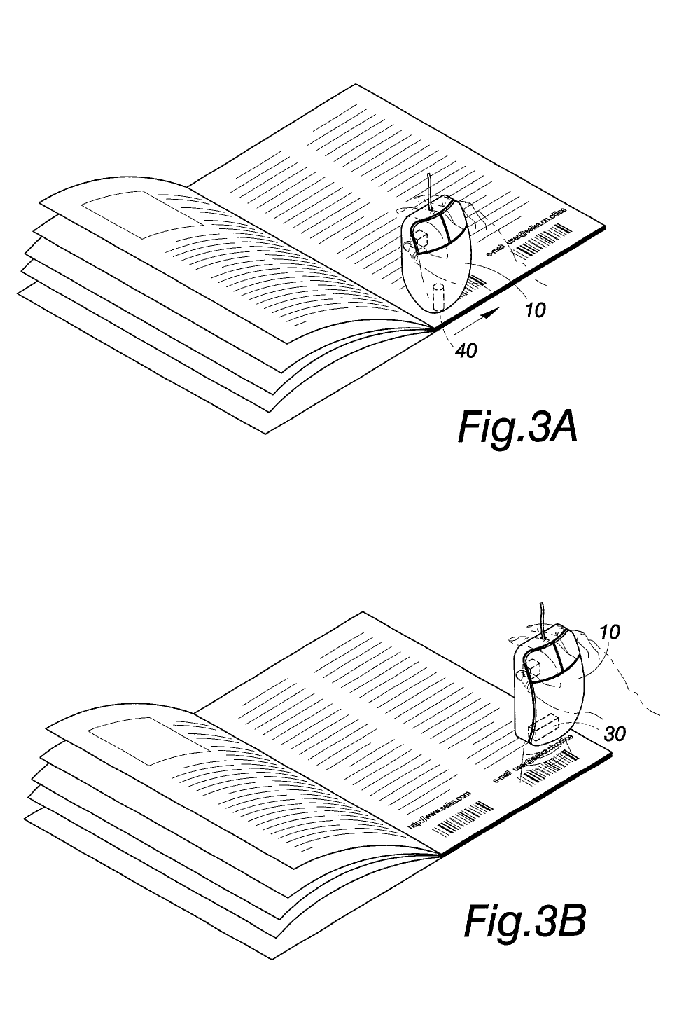

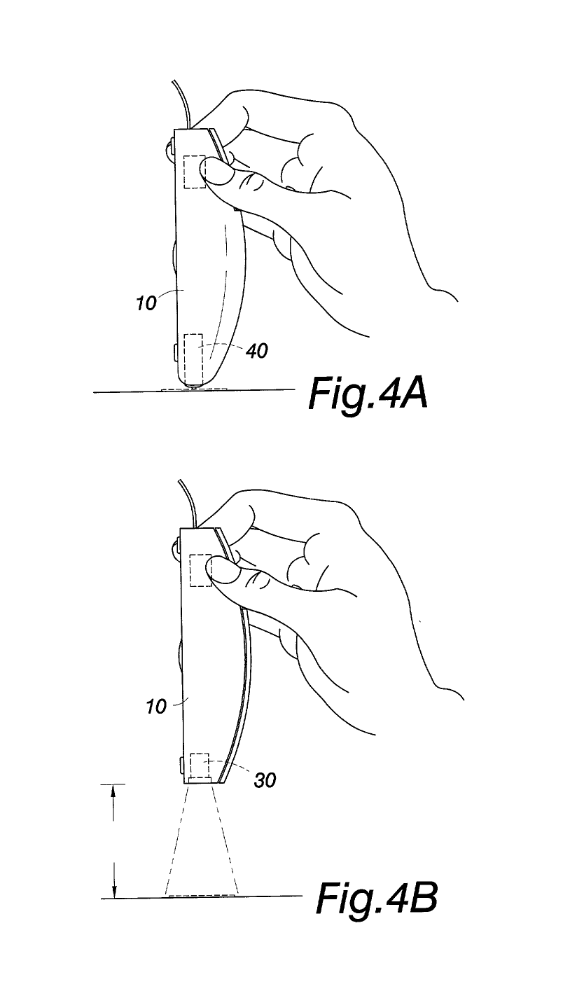

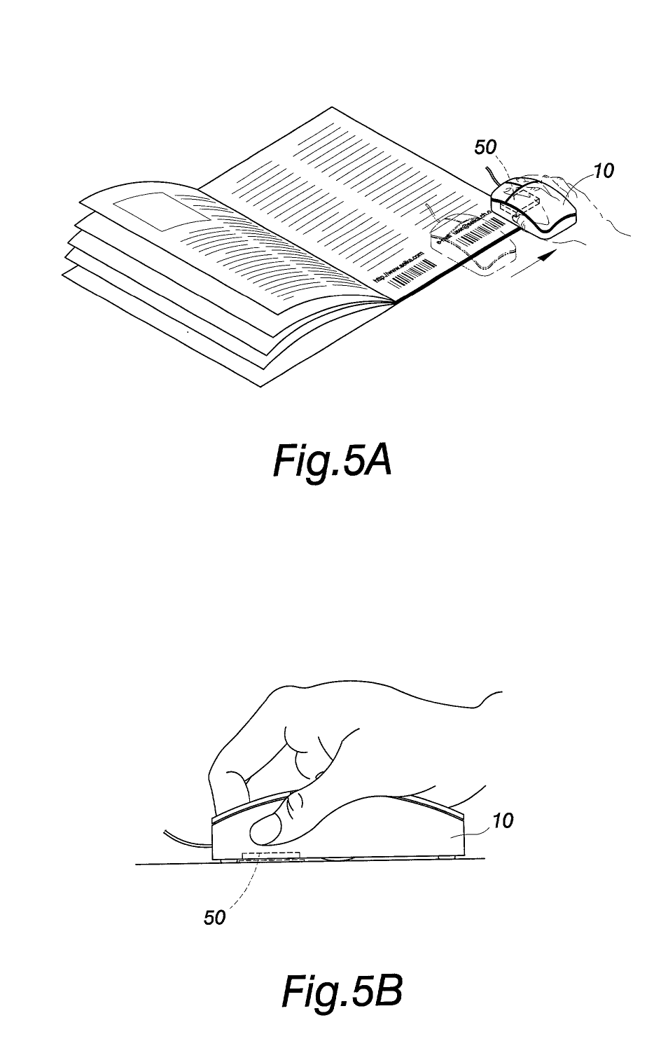

In practical utilization, as shown in FIGS. 3A, 3B and FIGS. 4A, 4B, if it is desired to scan a barcode, the end portion of the computer mouse 10 installed with a photo pen sensor 40 or a barcode sensor 30 is disposed to be perpendicular to the barcode to be scanned (i.e., the mouse is held vertically). It is only necessary to slide the mouse through the barcodes (referring to FIGS. 3A and 4A) or pass through the barcodes by a non-contact way. The operations for these two scanning ways are almost identical. For the embodiment that the barcode sensor 50 is installed to the bottom of the computer mouse 10 as FIG. 1D, the operation of this case is almost identical to the operation of a mouse. It is only necessary to switch the computer mouse into the scanning mode (described in the following). Then, the computer mouse 10 is flatly arranged on the barcode position and then moves through the barcodes to complete the scanning operation.

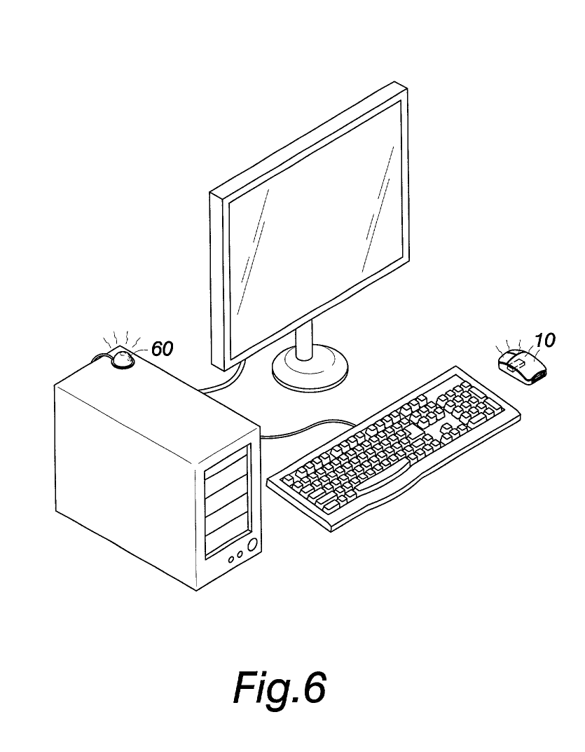

In the present invention, other than being installed in various barcode sensors (ID or 2D), and the installing position of the barcode sensor being adjustable, the present invention can be utilized in a wireless mouse, as illustrated in FIG. 6. The difference therebetween is that the output loop of the circuit board in the computer mouse 10 is a wireless circuit. A wireless transceiver 60 is used to connect the computer mainframe, and thus, the computer mouse 10 can transfer data of barcodes and mouse signals. Similarly, the present invention is suitable to mice of 2D (two dimensional), 3D (three dimensional), and 4D (four dimensional). Then the outputted scanning data can be connected to a respective web-site through a browser so as to have a more simple effect.

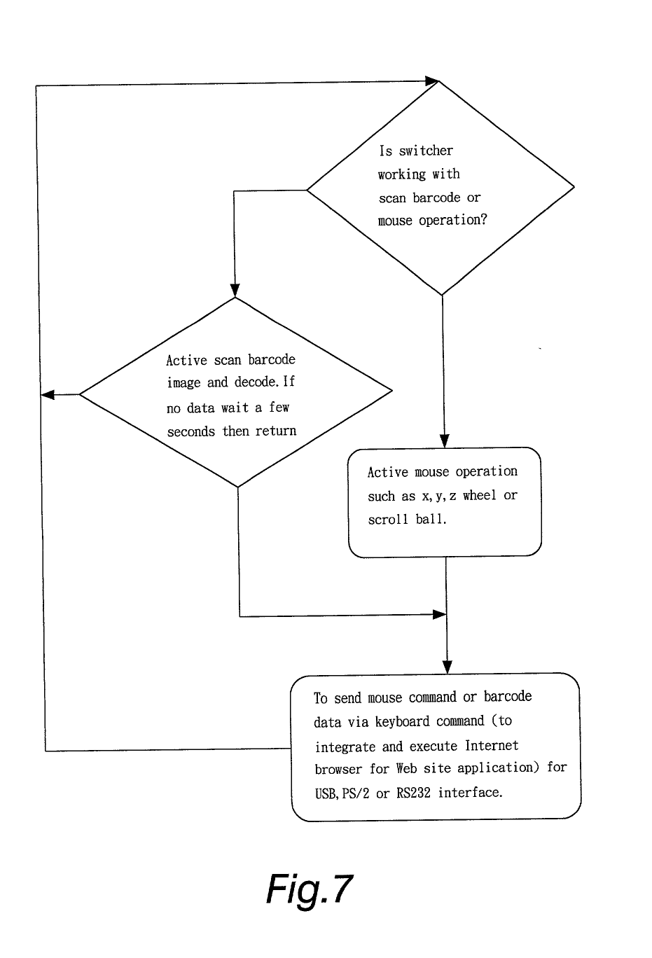

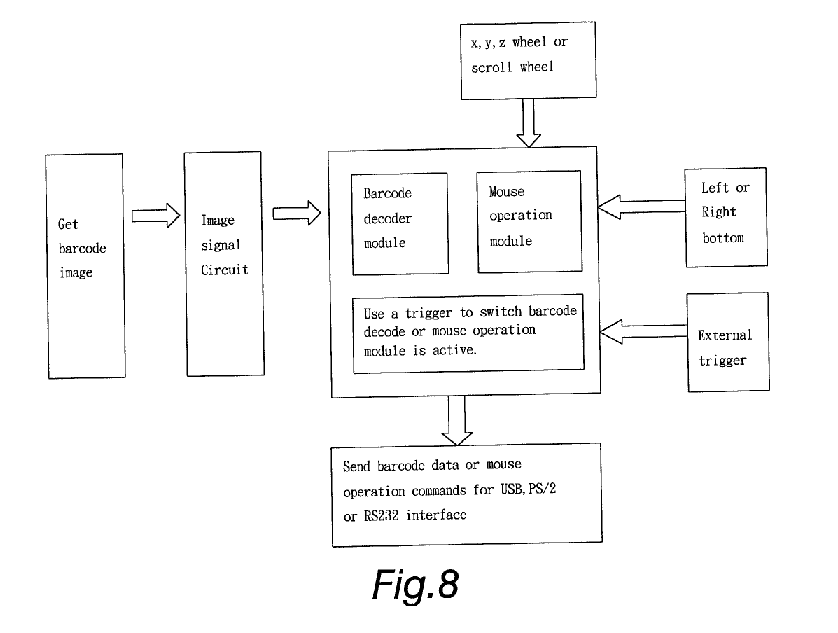

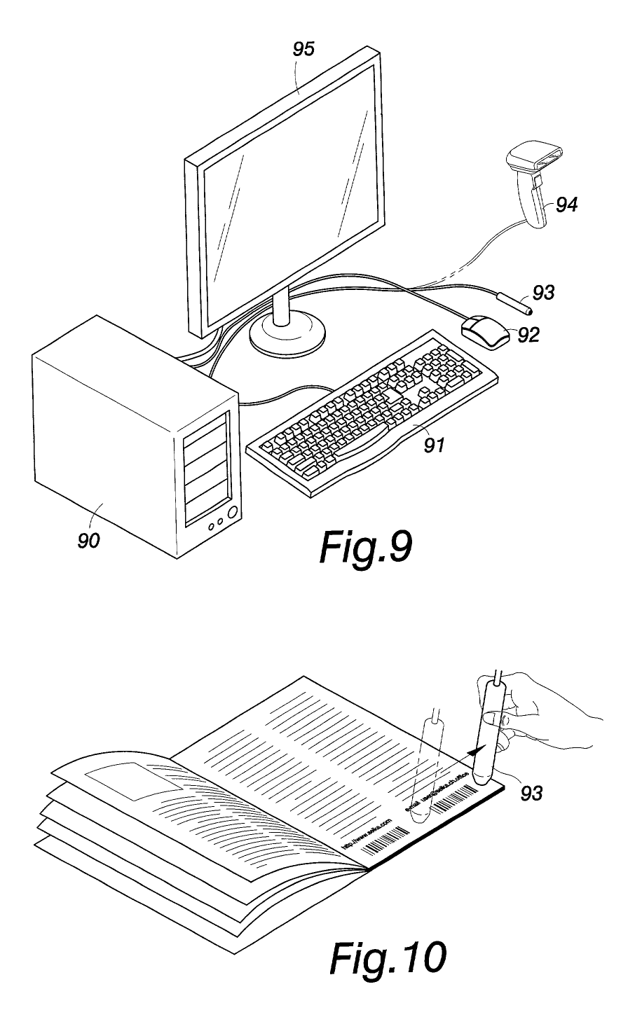

A circuit structure of the present invention is illustrated in FIG. 7. The circuit includes a barcode image sensor 11, an image processing circuit 12, a mouse sensor 13, a controller 14 including a barcode decoding module 141 and a mouse operation module 142, and a switching circuit 143; where the controller 14 further has inputs of a left or right button 144, a trigger button 145. The mouse sensor 13 outputs barcode data or mouse operation commands for USB, PS/2, or RS232 interfaces. The switching circuit 143 in the controller 14 is switched in two modes by the triggering of the triggering button 145. The triggering action can be performed by a key, a sensing switch (a pressure switch or other devices having identical function) or a button in a mouse. The operation mode may be changed conveniently. FIG. 8 shows an embodiment of the operation steps of triggering in different modes. The process is started in step 800, and then the process enters into step 801 for determine whether the device is working in a scanning barcode mode or in a mouse operation mode. If it is worked in mouse operation mode, then the process enters into the step 802 for actuating a mouse, such as actuating x, y, and z wheels or a scroll ball. Then, the process enters into step 805 for sending outputting data via keyboard command (to integrate and execute Internet browser for Web site application) for USB, PS/2, RS232 interface, and then the process enters into step 806 for ending the whole process. In step 801, if the process is not work in mouse operation mode, then the process enters into step 803 for waiting barcode data input for a time period. If there are barcode data, then process enters into step 804 for actuating scan barcode image and decoding the scanner data. Then, the process enters into step 805 for sending outputting data via keyboard command (to integrate and execute Internet browser for Web site application) for USB, PS/2, RS232 interface. Then the process enters into step 806 for ending the whole process. If in step 803, there is no barcode data, then the process return to step 801.

What is claimed is:

1. A barcode-readable computer mouse comprising:
at least one mouse key for sending mouse commands;
at least one mouse sensor for reading movement messages of the mouse;
a barcode sensor installed at a selected position of the mouse for reading barcodes; and
a circuit board having a mouse control circuit, an image control circuit, and a switching circuit; and
a trigger means for switching the circuit board between a mouse mode and an image mode.

2. The barcode-readable computer mouse as claimed in claim 1, wherein the barcode sensor is selected from a group containing a contact type barcode sensor and a non-contact type barcode sensor.

3. The barcode-readable computer mouse as claimed in claim 1, wherein the barcode sensor is installed at one of a plurality of end portions of a computer mouse.

4. The barcode-readable computer mouse as claimed in claim 1, wherein the barcode sensor is installed at a bottom of a computer mouse.

5. The barcode-readable computer mouse as claimed in claim 1, wherein the barcode image sensor is selected from a group containing a CCD sensor, an optic pen sensor, and a laser sensor.

6. The barcode-readable computer mouse as claimed in claim 1, wherein the mouse sensor is selected from a group containing a two dimensional mouse sensor, a three dimensional mouse sensor and a four dimensional mouse sensor.

7. The barcode-readable computer mouse as claimed in claim 1, wherein the mouse sensor is selected from a group containing a wired computer mouse and a wireless computer mouse.

8. The barcode-readable computer mouse as claimed in claim 1, wherein the trigger means is a trigger key or a sensing switch.

9. The barcode-readable computer mouse as claimed in claim 1, wherein the trigger means is actuated by pressing a button of the computer mouse.

10. The barcode-readable computer mouse as claimed in claim 1, wherein the data outputted from a mouse is transferred to a connected web-cite using a browser.
